(19) United States
(12) Patent Application Publication
(10) Pub. No.: US 2013/0118642 A1
(43) Pub. Date: May 16, 2013

(54) ROTARY PLANING TOOL

(71) Applicant: Arbortech Industries Limited, Malaga (AU)

(72) Inventor: Kevin Ross Inkster, Malaga (AU)

(73) Assignee: ARBORTECH INDUSTRIES LIMITED, Malaga (AU)

(21) Appl. No.: 13/672,133

(22) Filed: Nov. 8, 2012

Related U.S. Application Data
(63) Continuation-in-part of application No. 29/421,007, filed on May 4, 2012, now abandoned.
Application No. 29/421,007 is a continuation-in-part of application No. 29/421,006, filed on May 4, 2012, now Pat. No. D678370.
Application No. 29/421,006 is a continuation-in-part of application No. 29/421,008, filed on May 4, 2012, now Pat. No. D672795.

(30) Foreign Application Priority Data
Nov. 10, 2011 (AU) 150492011
Nov. 10, 2011 (AU) 150502011
Nov. 10, 2011 (AU) 150512011

(51) Int. Cl. B27G 13/10

(52) U.S. Cl. CPC B27G 13/10
USPC 144/230

(57) ABSTRACT

A rotary planing tool comprising a disk having a central mount for mounting on an angle grinder. The rotary planing tool has a working radial surface in which substantially radially extending blades are attached. The working radial surface has radial voids extending before a leading edge of each blade. The blades extend proud of the working radial surface, and each have a curvature tending away from the working radial surface into the circumference of the disk, and are arranged to not extend past the outer circumference of the disk.

### CROSS-REFERENCE TO EARLIER APPLICATION

This application is a Continuation-in-Part application from U.S. design patent applications 29/421,007, 29/421,006 and 29/421,008, all filed on May 4, 2012, which claim priority respectively from Australian design applications 15049/2011, 15050/2011, 15051/2011, all filed under a single design application on Nov. 10, 2011, the entireties of which are incorporated by reference herein.

### TECHNICAL FIELD

This invention relates to a rotary cutting tool, and in particular to a rotary planing tool. This invention has particular application in use as a tool for sculpting objects from wood.

### BACKGROUND ART

The following discussion of the background art is intended to facilitate an understanding of the present invention only. It should be appreciated that the discussion is not an acknowledgement or admission that any of the material referred to was part of the common general knowledge in any jurisdiction as at the relevant priority dates of the application.

Rotary cutting tools have been used for cutting and shaping in the past. A particular example is a circular saw, used for cutting materials in a straight line, particularly to slice through material. These are typically used for slicing off predetermined lengths of material from stock.

Similarly, grinding wheels have been used to abrade materials, and these can cut in a slicing action as well as being able to be used in order to sculpt. More portable cutters are mounted in hand held tools often referred to as angle grinders have had various types of cutting tools mounted to them, from grinding and cutting discs that cut on the radial face and the circumferential edge, to a wood carving tool which was the subject of U.S. Pat. No. 4,850,407 of which the present inventor was co-applicant.

Normal freehand wood shaping blades such as the Woodcarver blade of our previous patent, have cutting members on the perimeter or edge of the blade and are primarily designed to cut and shape wood on the perimeter though they can be laid at various angles and may even be laid flat against a surface while rotating. They remove wood rapidly at any contact with a surface of wood and therefore it is very difficult obtain a very smooth surface or use any guide or template. They are particularly hazardous in the tight space or corner where teeth on the perimeter can bite into the wood causing the machine to lose control or kick back.

If the TurboPlane is brought into contact with a surface at right angles to the axis, I.e. if the perimeter contacts a surface at exactly right angles, it will ride on the surface but will not cut or grab. If however the operator tilts the blade so that the cutting tips start to contact the surface, it will start to cut but only in the direction of the axis away from the driving means. This allows precise control of the aggressiveness of cutting at the perimeter. To cut a hollow such as a bowl shape into a piece of wood, one scoops the blade into the surface in a similar manner as an ice cream scoop. The advantage of this method is that the blade rides on the benign perimeter giving excellent control and preventing the perimeter from biting or grabbing in a confined space or corner.

Throughout the specification unless the context requires otherwise, the word “comprise” or variations such as “comprises” or “comprising”, will be understood to imply the inclusion of a stated integer or group of integers but not the exclusion of any other integer or group of integers.

Throughout the specification unless the context requires otherwise, the word “include” or variations such as “includes” or “including”, will be understood to imply the inclusion of a stated integer or group of integers but not the exclusion of any other integer or group of integers.

### SUMMARY OF INVENTION

It is an object of this invention to provide a rotary planning tool that at least provides an alternative to hitherto known cutting or planing tools.

In this specification the term “workpiece” is used to describe an object being worked on by the rotary planing tool. As the rotary planing tool of the invention has particular application in wood carving and wood planing, typically, a workpiece will be a piece of wood, but the invention has application beyond this.

In accordance with the invention there is provided a rotary planing tool comprising a disk having a central mount for mounting on a motor, the rotary planing tool having a working radial surface in which substantially radially extending blades are attached, the working radial surface having a radial void extending before a leading edge of each radially extending blade, said radially extending blades extending proud of said working radial surface, said each said radially extending blade having a curvature tending away from the working radial surface into the circumference of said disk, and each said radially extending blade being arranged to not extend past the outer circumference of said disk. The inventor has found that with the blade not extending past the outer circumference of the disk, the spinning blade can be urged onto the workpiece, edge on, and the spinning circumferential edge will not “bite” allowing the planing tool to be positioned on the work before cutting or planing commences. The circumference of the disk is best formed in a true circle, so that when spinning and held edge on against a workpiece, there is minimal vibration.

Preferably, the radially extending blades extend proudly from the working radial surface in a smooth transition in height from being flush with the circumferential edge to a maximum height of the radially extending blades at a position or extent along said working radial surface way from the circumferential edge.

In a preferred form of the invention, the working radial surface has a raised annular portion, and a recessed central portion in which said mount is located. This provides for mounting hardware such as bolts of the like to be recessed, so as not to come into contact with an object being worked by the rotary planing tool.

With the radially extending blade having a curvature tending away from the working radial surface into the circumference of said disk, and the height of the radially extending blade increasing moving away from the circumferential edge, the cutting edges have a gradually increasing bite as the pitch of the planing tool is moved away from the circumferential edge contacting the workpiece toward the radial extent of the planing tool contacting the workpiece. As a result a smooth finish is achieved at the edge of where the planing tool operates. In comparison, tools that cut at the circumference will leave ridges in the workpiece, as the tool is moved.

For better utility, the radially extending blades extend entirely across said raised annular portion, and further still, for best utility, the radially extending blades have a curvature tending away from the working radial surface into the recess, on an inner circumference of the raised annular surface.

In a particularly preferred arrangement, the radially extending blades extend proud of the inner circumference of said raised annular portion and in said recess. It is preferred that the cutting edges have a gradually decreasing bite tending into said recess.

The mount may be an aperture which would usually be the case where the planing tool is fitted to an angle grinder.

For better stability, it is preferred that the radially extending blades cutting edges trail the true radial extent of said disk.

For better cutting action, the radially extending blades cutting edges are pitched at an angle to the true radial extent of said disk. That angle may lie in the range of from 3 degrees to 30 degrees, 5 degrees to 25 degrees or 10 to 15 degrees, with about 15 degrees being optimum for a disk diameter of around 100 mm (4 inches).

Preferably the inner edge of the blade trails the outer edge across the raised annular portion.

Preferably the maximum height that the cutting edges from the working radial surface is up to 4 mm, with between 2 mm and 3 mm being particularly suitable for planing wood.

Preferably the radial void extending before a leading edge of each radially extending blade comprises an aperture extending entirely through the working radial surface.

Preferably each aperture extends before a leading edge before the radial extent only of each radially extending blade, so that the circumferential edge of the disk is unbroken.

Alternatively, the radial void extending before a leading edge of each radially extending blade may comprise a recess located in front of each radially extending blade.

In either arrangement, the radial void extending before a leading edge of each radially extending blade provides a space for fragments produced from the planing operation of the tool to be discharged away from the workpiece.

In a particularly advantageous and preferred alternative embodiment, the radially extending blades each comprise a true circular disk, and the raised annular surface has a radius of curvature greater than the radius of curvature of the true circular disk.

It is particularly preferred in this alternative embodiment that the radially extending blade is removable from the disk. It may be secured thereto by a screw, which may be centrally located in the true circular disk. Central location allows rotation of the blade to a fresh sharp edge, when the blade blunts in a particular portion, and replacement when the blade is completely blunt. The blade may have a concave radial leading surface.

The invention provides a radical departure from hitherto known freehand wood shaping blades which cut at their perimeter, giving rise to some unexpected advantages.

### BRIEF DESCRIPTION OF DRAWINGS

Several embodiments of the invention will now be described in the following description made with reference to the drawings, in which:

FIG. 1 is a front isometric view of a rotary planing tool according to a first embodiment;

FIG. 2 is a back isometric view of a rotary planing tool according to the first embodiment;

FIG. 3 is a side isometric view of a rotary planing tool according to the first embodiment;

FIG. 4 is a side view of a rotary planing tool according to the first embodiment;

FIG. 5 is a back view of a rotary planing tool according to the first embodiment;

FIG. 6 is an end view of a rotary planing tool according to the first embodiment;

FIG. 7 is a front view of a rotary planing tool according to the first embodiment;

FIG. 8 is a front isometric view of a rotary planing tool according to a second embodiment;

FIG. 9 is a back isometric view of a rotary planing tool according to the second embodiment;

FIG. 10 is a side isometric view of a rotary planing tool according to the second embodiment;

FIG. 11 is a side view of a rotary planing tool according to the second and most preferred embodiment;

FIG. 12 is a back view of a rotary planing tool according to the second embodiment;

FIG. 13 is an end view of a rotary planing tool according to the second embodiment;

FIG. 14 is a front view of a rotary planing tool according to the second embodiment;

FIG. 15 is a front isometric view of a rotary planing tool according to a third embodiment;

FIG. 16 is a back isometric view of a rotary planing tool according to the third embodiment;

FIG. 17 is a side isometric view of a rotary planing tool according to the third embodiment;

FIG. 18 is a side view of a rotary planing tool according to the third embodiment;

FIG. 19 is a back view of a rotary planing tool according to the third embodiment;

FIG. 20 is an end view of a rotary planing tool according to the third embodiment;

FIG. 21 is a front view of a rotary planing tool according to the third embodiment;

FIG. 22 is a side view from below showing the rotary planing tool of the second and most preferred embodiment fitted to an angle grinder, showing the circumferential edge contacting work piece in the form of wood about to be carved;

FIG. 23 is a side view from below of the rotary planing tool in FIG. 22 but showing tool tilting down as it begins to plane;

FIG. 24 is a perspective view from above showing the rotary planing tool of the third embodiment in operation, pushing in across to the right direction (from the point of view of the operator) and planing as it is moved;

FIG. 25 is a side plan view of an angle grinder with a cross-section through the rotary planing tool of FIG. 24, while the rotary planing tool is being pushed forward, cutting in a forward direction;

FIG. 26 is a side plan view of an angle grinder with a cross section through the rotary planing tool of FIG. 24, showing the rotary planing tool being pulled backwards, cutting in a reverse direction;

FIG. 27 is a side plan view of an angle grinder with a cross-section through the rotary cutting tool of the third embodiment, showing operation against a guide/template;

FIG. 28 is a perspective view from above of the rotary cutting tool according to the third embodiment, showing operation against a guide/template;

FIG. 29 is a top plan view of a rotary cutting tool according to a fourth embodiment;

FIG. 30 is a bottom plan view of the rotary cutting tool according to the fourth embodiment;

FIG. 31 is a top perspective view of the rotary cutting tool according to the fourth embodiment;

FIG. 32 is a bottom perspective view of the rotary cutting tool according to the fourth embodiment;

FIG. 33 is an edge view of the rotary cutting tool according to the fourth embodiment;

FIG. 34 is a cross section view along the blade of the rotary cutting tool according to the fourth embodiment;

FIG. 35 is a cross section view normal to the blade of the rotary cutting tool according to the fourth embodiment;

FIG. 36 is a view of the rotary cutting tool according to the fourth embodiment shown fitted to a grinder and in use;

FIG. 37 is a top plan view of a rotary cutting tool according to a fifth embodiment;

FIG. 38 is an end plan view of the rotary cutting tool according to the fifth embodiment;

FIG. 39 is a side plan view of the rotary cutting tool according to the fifth embodiment;

FIG. 40 is a bottom view of the rotary cutting tool according to the fifth embodiment;

FIG. 41 is a top perspective view of the rotary cutting tool according to the fifth embodiment;

FIG. 42 is a bottom perspective view of the rotary cutting tool according to the fifth embodiment; and

FIG. 43 is a view of the rotary cutting tool according to the fifth embodiment shown fitted to a grinder and in use.

### DESCRIPTION OF EMBODIMENTS

The first, second and third embodiments are rotary planing tools 11 for planing wood or the like.

The rotary planing tool 11 is provided in the form of a circular disk 13 which has a central mount in the form of a central circular aperture 15. The central circular aperture 15 is of a diameter which is industry standard so the rotary planing tool 11 can be mounted on a motor in the form of an angle grinder 17. The rotary planing tool 11 is mounted to the spindle 19 of the angle grinder and secured using a fastener 21, as used for grinding disks and cut-off disks in known fashion.

Shims (not shown) can be provided to adapt the rotary planing tool 11 for mounting on angle grinders having a smaller diameter spindle size. Spacers (also not shown) can be provided if necessary to space the rotary planing tool 11 away from the elevation of the guard fitted to the angle grinder 17, so the rotary planing tool 11 can be laid flat on a workpiece, so that the guard does not interfere with the operation of the rotary planing tool 11.

The rotary planing tool 11 has a working radial surface 23 on one face which is exposed when the rotary planing tool 11 is fitted to an angle grinder 17. The working radial surface 23 extends to the outside radius 25 of the rotary planing tool 11. The working radial surface 23 is formed in a raised annular configuration or a torus 27 in which substantially radially extending blades 29 are attached. The blades 29 extend substantially radially in the sense that they extend at an angle φ of about 15 degrees from the true radius from the center of the disk 13, with the inner part of the blades 29 trailing the outer part, in the direction 30 of rotation of the disk 13. Angling of the blades improves the planing action for much the same reason as the operation of a hand held plane is improved if the plane is held at an angle to the direction of travel. The selection of the correct angle depends on a number of factors including the radial extent of the blade across the raised annular portion, but the correct angle can be determined by experimentation or calculation. If the angle is too sharp, the blades will tend to pull the cutting tool into the work, but if angled in the opposite direction (ie with the inner edge of the blade leading the outer edge), the blades will tend to push the cutting tool away from the work.

The blades 29 extend most forward toward the outer circumference 31 of the disk 13, trailing rearward toward the center. The blades 29 are formed of tungsten carbide and the disk 13 is machined from solid steel. The rear-side (non-working surface) of the disk 13 is also machined out, leaving the disk of a thickness of about 2 mm, in order to reduce weight. This weight reduction minimises issues with gyroscopic forces. The disk of the first, second and third diameters has a diameter the same as grinding wheels and cut-off disks for typical angle grinders, that is in the order of 100 mm.

The working radial surface 23 is provided with a radial void 33 extending before a leading edge 35 of each radially extending blade 29. These voids 33 are provided in the form of apertures which extend entirely through the disk 13, and provide for discharge of shavings from the planing action of the rotary planing tool 11. The working radial surface 23 being positioned either side of a blade 29 and void 33 acts in a similar fashion to the heel and toe of a hand operated/manual wood plane.

The radially extending blades 29 extend proud of the working radial surface 23 by about 2 mm at the highest elevation, and are curved to follow the torus 27 or raised annular configuration of the radial working surface 23. The radially extending blades 29 have a curvature tending away from the working radial surface 23 into the circumference of the disk in the sense that they curve around to meet the outer circumference 31 of the disk 13, but none of the blades 29 extend past the outer circumference 31 of the disk 13. This results in the outer circumference 31 not having a planing or cutting action when the rotary planing tool 11 is held edge on to the workpiece 37. Each aperture extends before a leading edge before the radial extent only of each radially extending blade 29, so that the circumferential edge 31 of the disk 13 is unbroken.

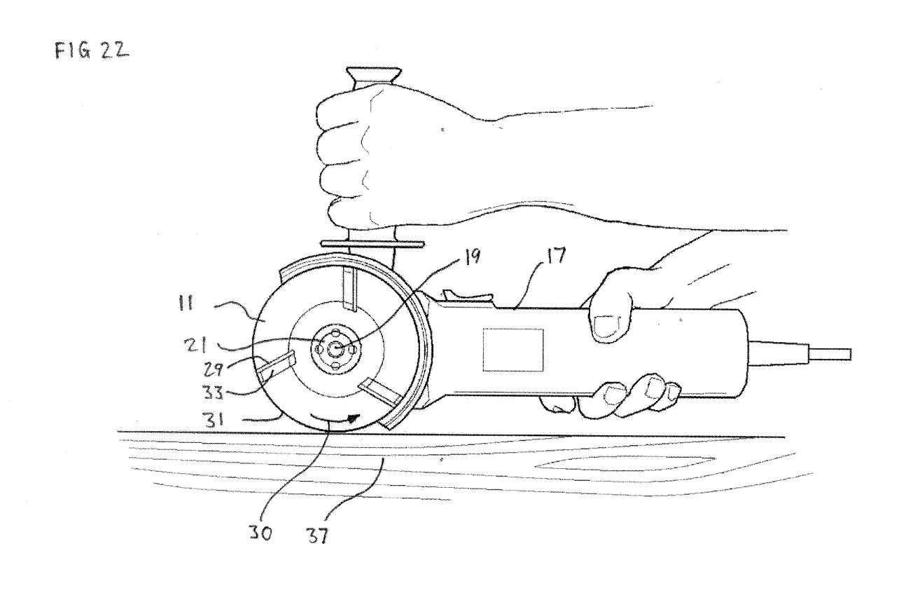

With the blade not extending past the outer circumference 31 of the disk, the spinning blade can be urged onto the workpiece 37, circumferential edge-on as is shown in FIG. 22, and the spinning circumferential edge 31 will not “bite” allowing the planing tool to be positioned on the work before cutting or planing commences. The circumferential edge 31 being unbroken in the vicinity of the blades 29 also lend to the smooth operation of the planing tool.

The radially extending blades 29 extend proudly from the working radial surface 23 in a smooth transition in height from being flush with the circumferential edge 31 to the maximum height of the radially extending blades 29 which extends across most of the torus 27 of the working radial surface 23, away from the circumferential edge 31.

As can be seen in the drawings, the working radial surface 23 has a raised annular portion 27, and a recessed central portion 39 with a lower elevation in which the central circular aperture 15 is located. This provides for the mounting nut 21 and spindle 19 of the angle grinder 17 to be recessed, so they do not come into contact with an object being worked by the rotary planing tool.

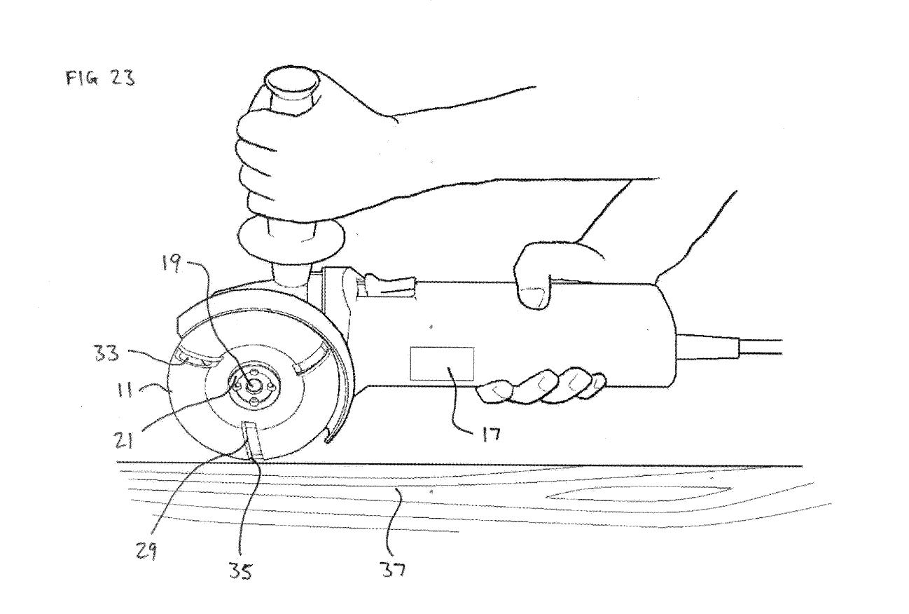

With the radially extending blades 29 having a curvature tending away from the working radial surface into the circumference of said disk, and the height of the radially extending blade increasing moving away from the circumferential edge, the cutting edges have a gradually increasing bite as the pitch of the planing tool is moved away from the circumferential edge 31 contacting the work piece as shown in FIG. 22 toward the radial extent of the planing tool beginning to contact the work piece as shown in FIG. 23. As a result a smooth finish is achieved at the edge of where the planing tool operates. In comparison, prior art tools that cut at the circumference will leave ridges in the workpiece, as the tool is moved.

On the inner edge of the blades 29 the curvature extends into the recessed central portion 37, and the 2 mm elevation is slightly decreased to about 1.5 mm, so that the blades 29 can cut on the inside in region of the recessed central portion 39, when the rotary planing tool 11 is pulled in a direction toward its aperture 15 when cutting particularly deeply into a workpiece, with the blade elevated at a steep angle.

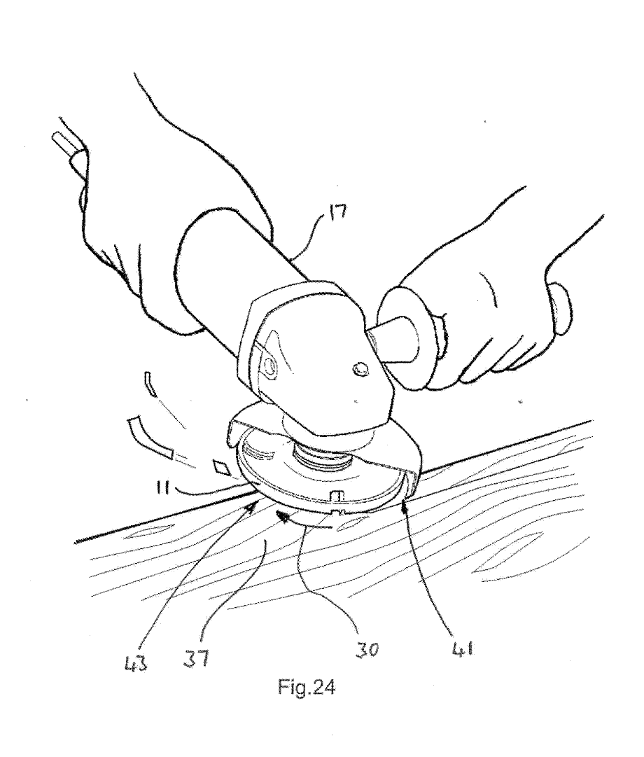

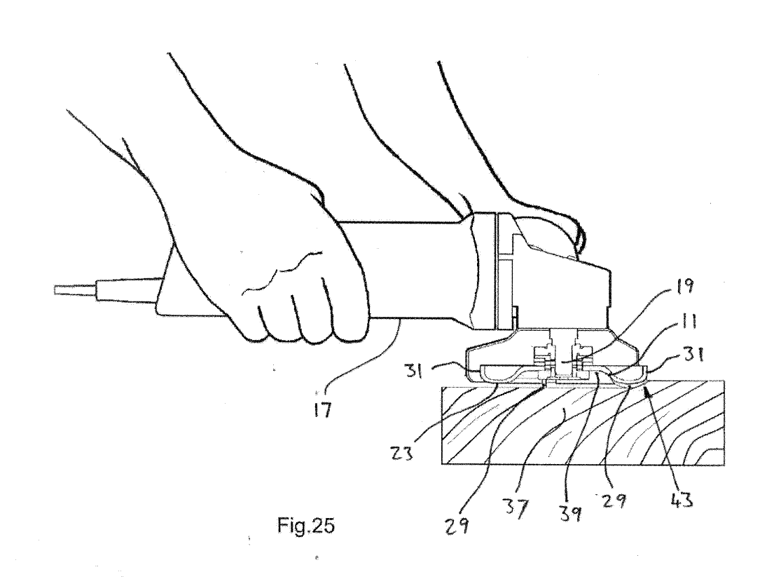

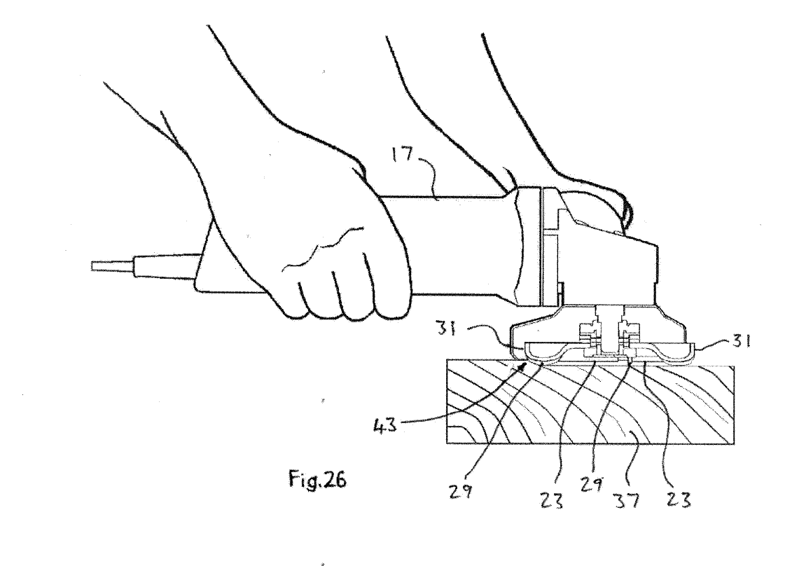

In FIG. 24 the angle grinder 17 is being held elevated and moved to the right from the operator's view point, with the trailing edge 41 of the rotary planing tool 11 being held low compared with the leading edge 43. The angle grinder 17 may be held in this manner for free form planing (although a straight line is shown in the workpiece 37, in FIG. 24) and sculpting. FIG. 25 shows the angle grinder 17 positioned so the rotary planing tool 11 sits flat on the workpiece 37. In FIG. 25, the angle grinder 17 is being pushed forward by the operator (to the right in the drawing), and the rotary planing tool 11 planes at the leading edge 43, immediately under the circumferential edge 31. In FIG. 26, the angle grinder 17 is also positioned so the rotary planing tool 11 sits flat on the workpiece 37. In FIG. 26, the angle grinder 17 is being pulled backward by the operator (to the left in the drawing), and the rotary planing tool 11 planes at the leading edge 43, immediately under the circumferential edge 31.

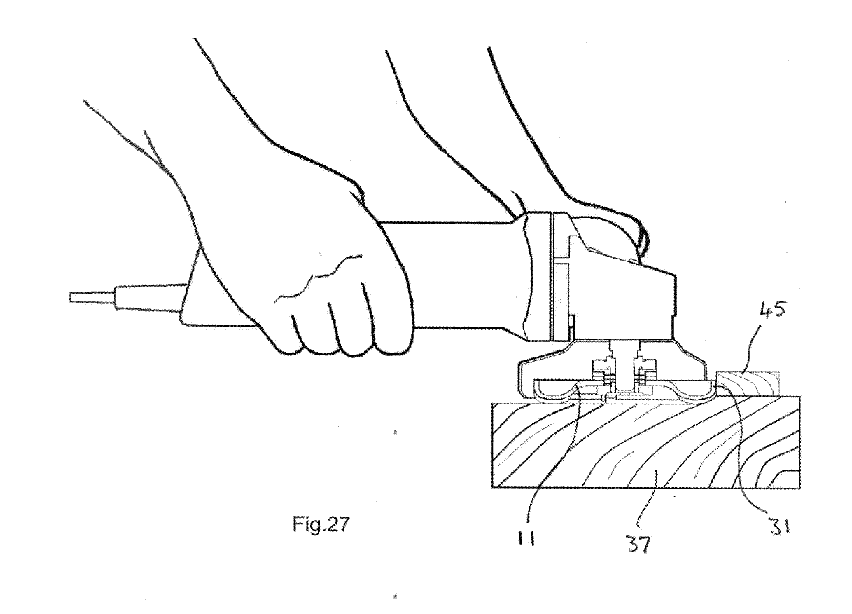

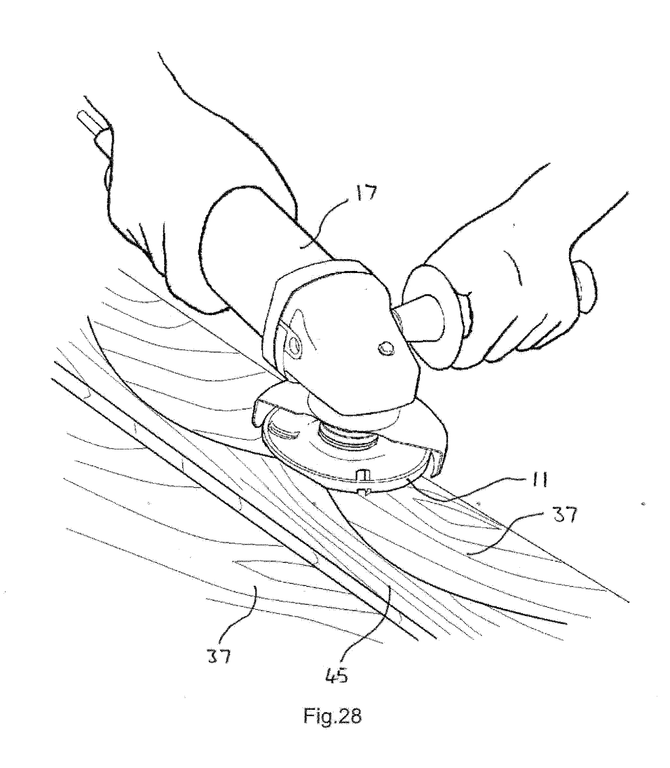

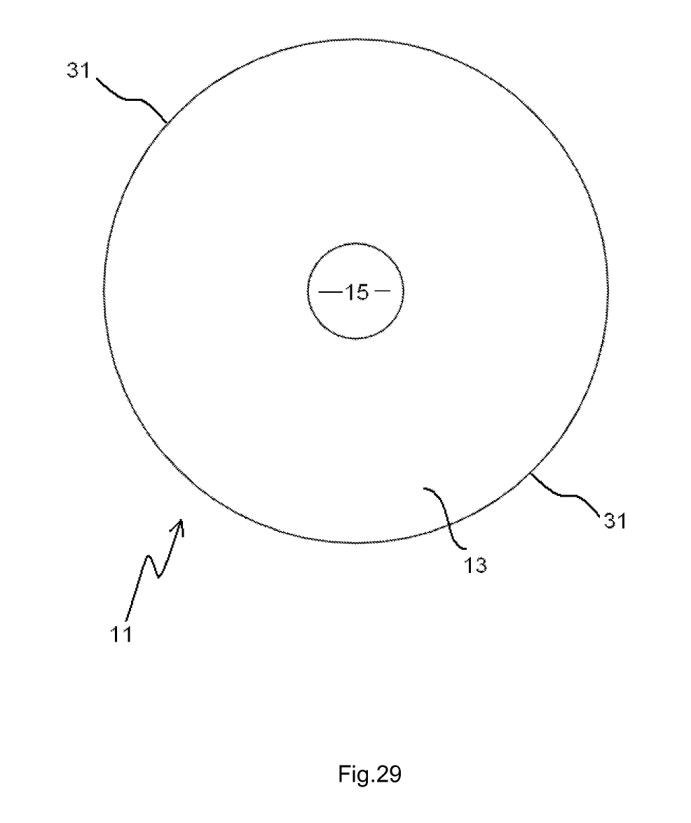

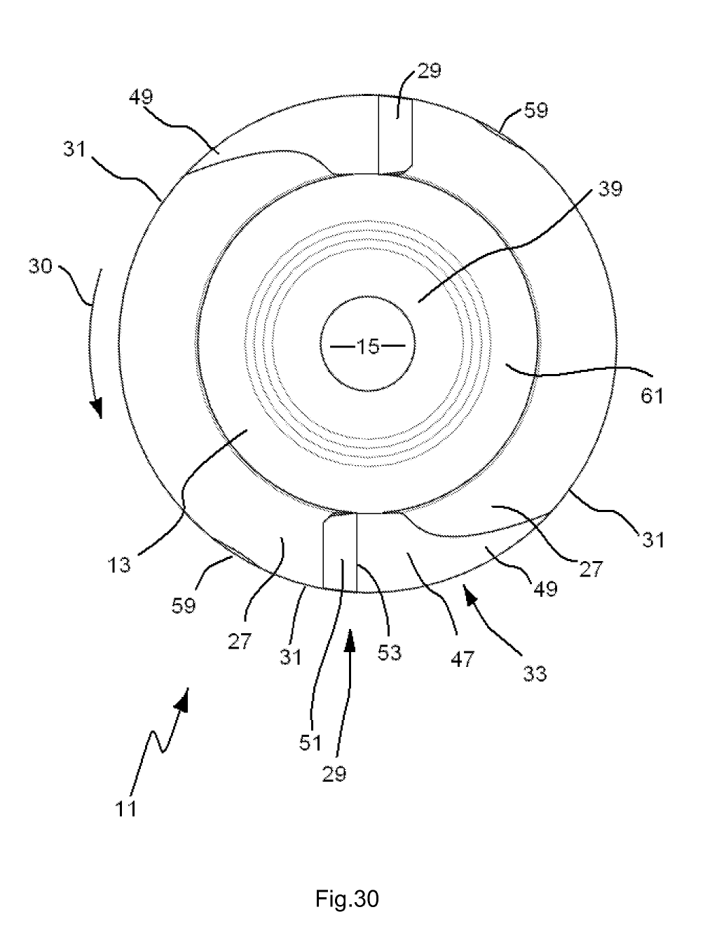

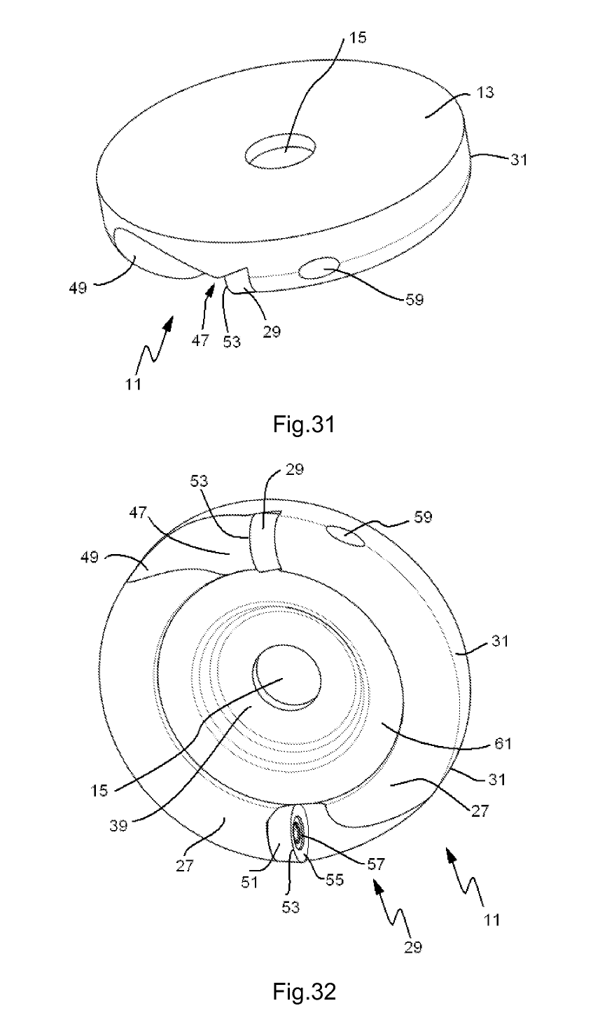

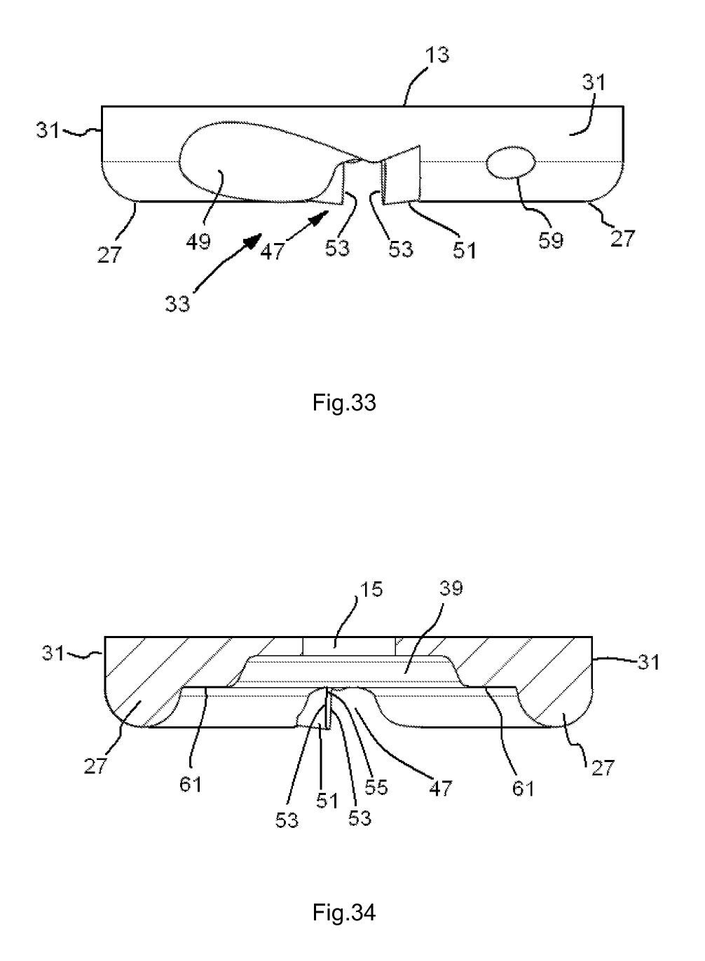

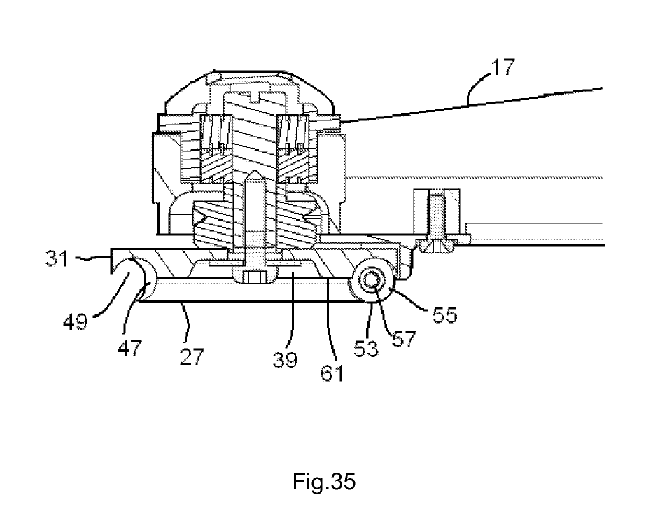

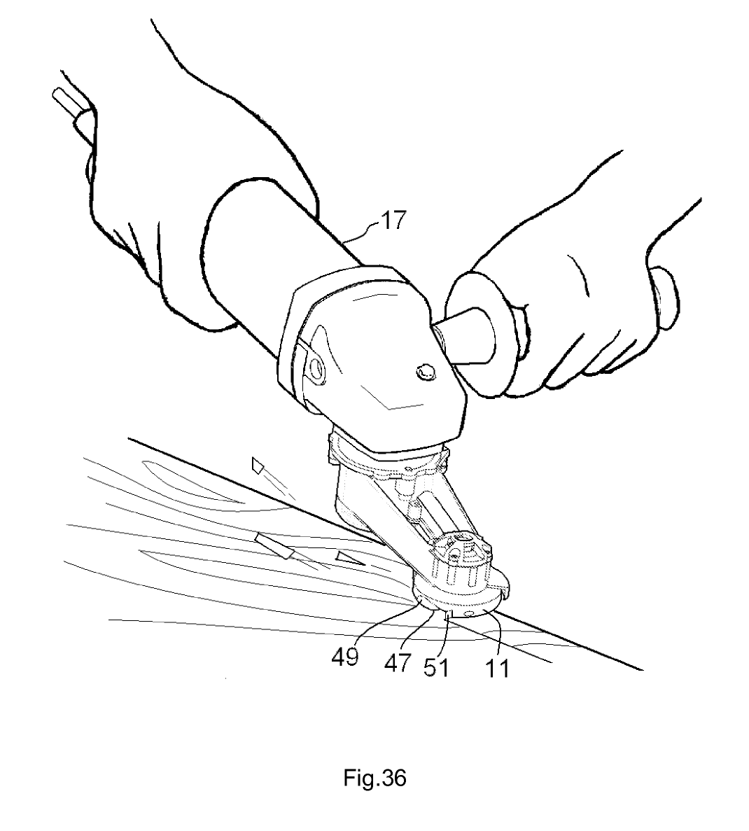

FIGS. 27 and 28 show use of a template 45 which is located temporarily on top of the workpiece 37. The template 45 may be made from a piece of plywood, and as a consequence of the circumferential edge 31 of the rotary planing tool 11 not having any protruding blades, the template is not planed or abraded. The rotary planing tool 11 can be pushed down into the workpiece 37 to plane or sculpt. Once the rotary planing tool 11 is at a sufficient depth into the workpiece 37, the wall planed into the workpiece acts as a template to further guide the rotary planing tool 11.

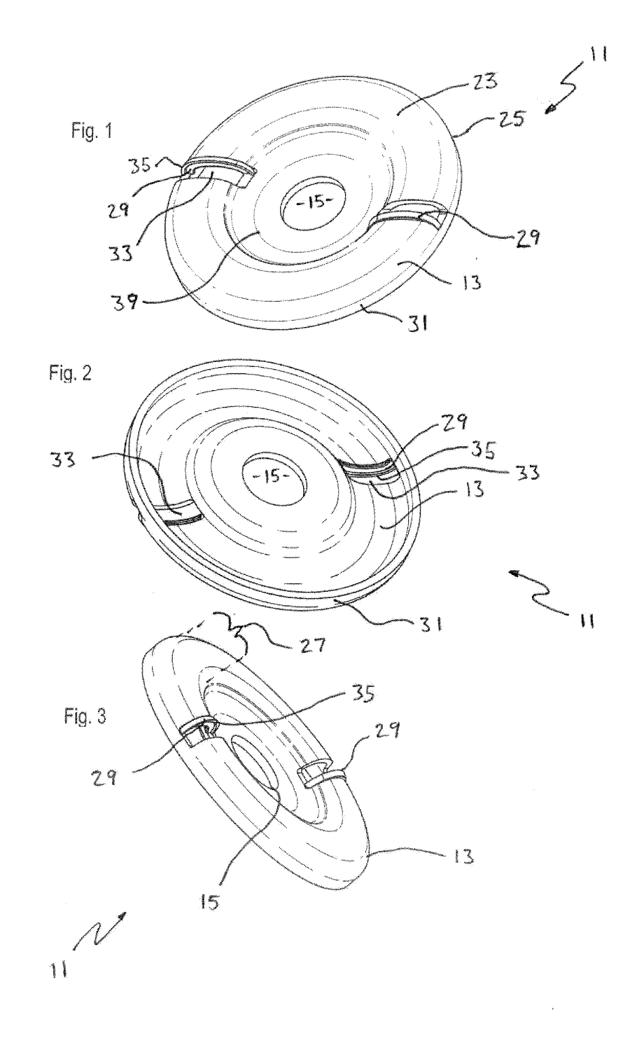

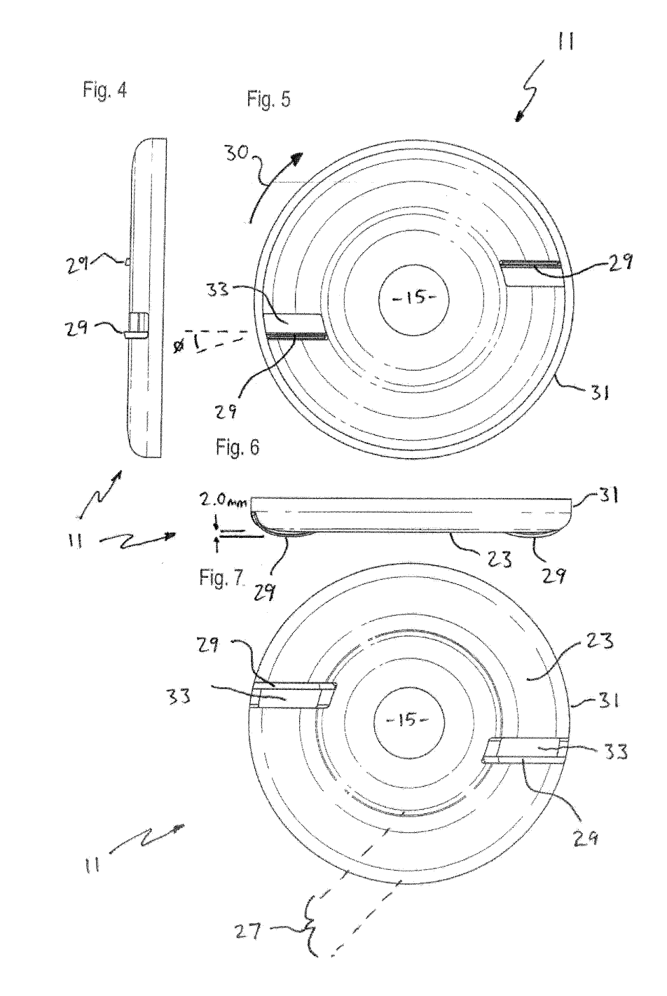

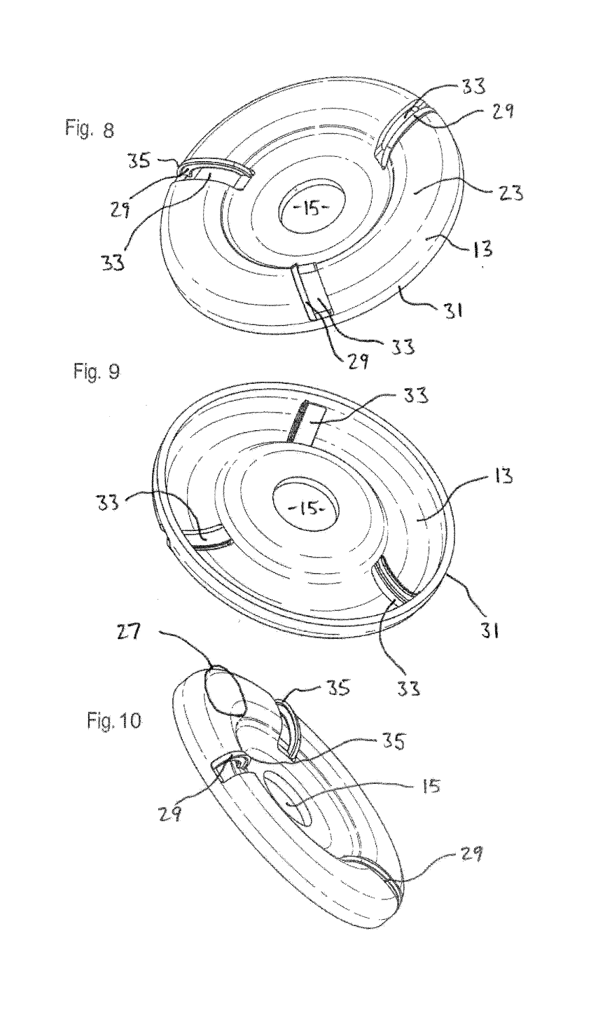

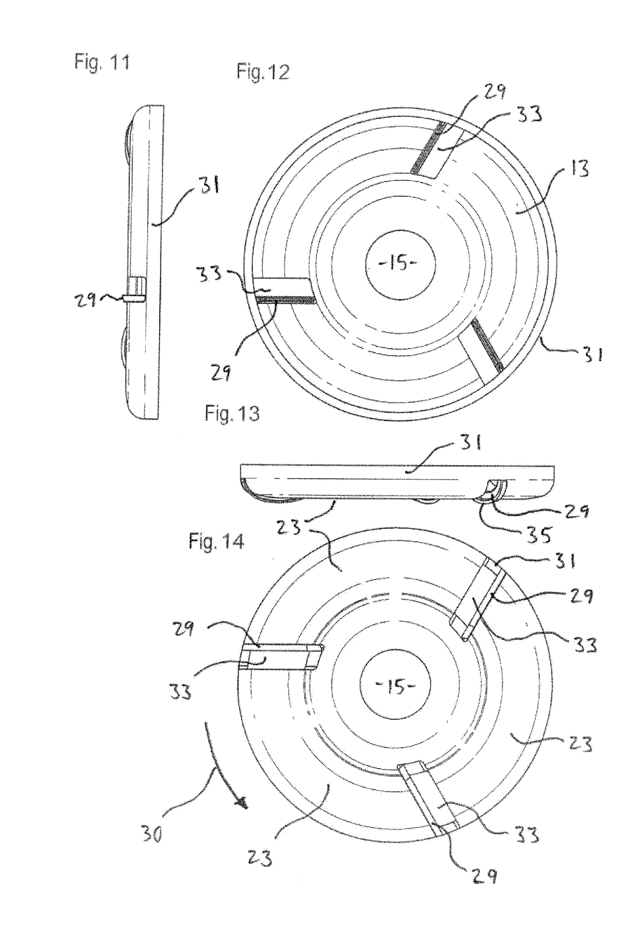

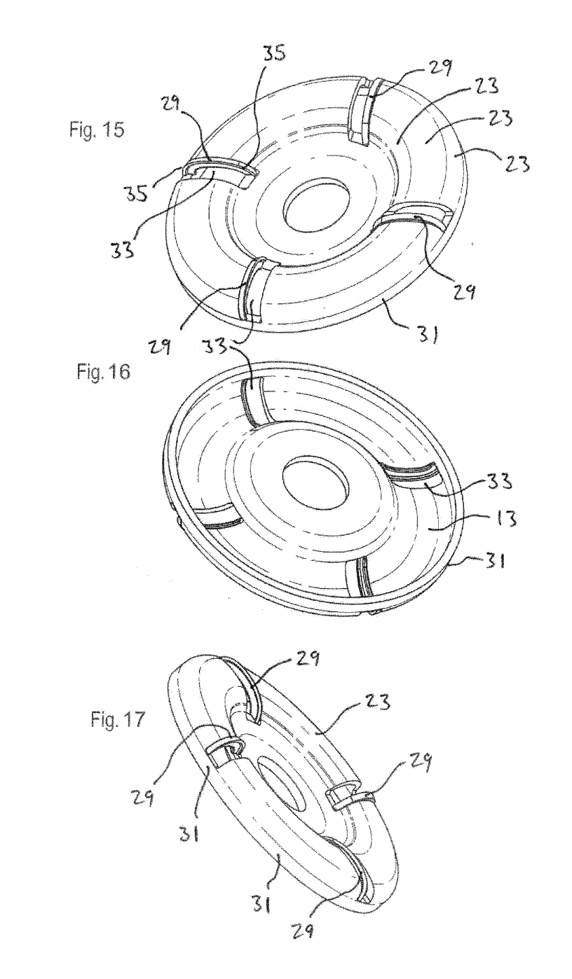

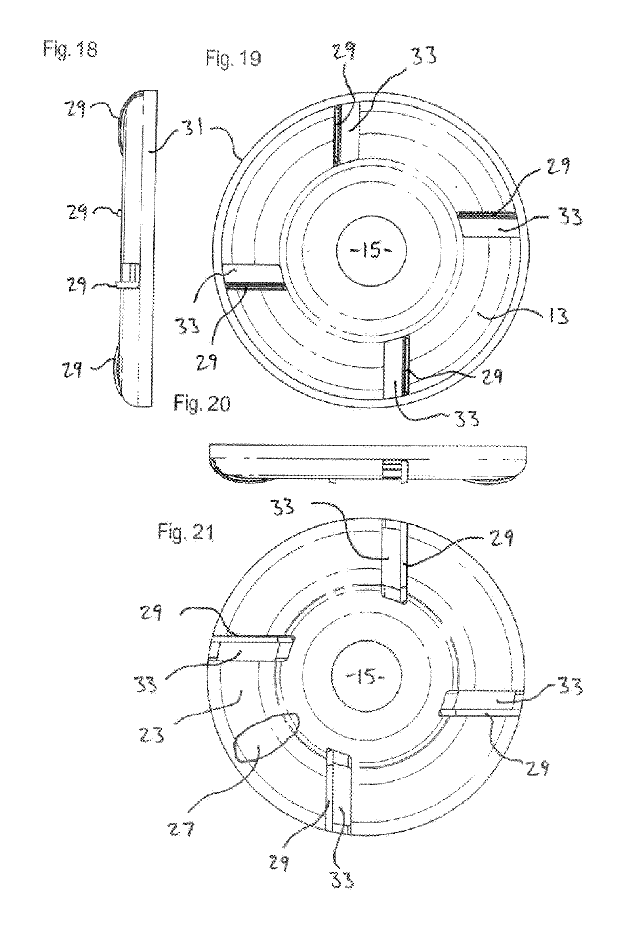

As discussed in the introduction, the first embodiment of the rotary planing tool is shown in FIGS. 1 to 7, the second embodiment is shown in FIGS. 8 to 14 and the third embodiment is shown in FIGS. 15 to 21. These differ only in the number of blades 29 and associated voids 33, the first embodiment having two blades 29 and associated voids 33, the second embodiment which is the most preferred having three blades 29 and associated voids 33, and the third embodiment having four blades 29 and associated voids 33. Typical angle grinders have a speed of 10,000 RPM to 12,000 RPM, and the embodiments described have a rated speed limit of 15,000 RPM.

The rotary planing tool 11 of the fourth embodiment is similar to that of the previous embodiments, and like numbers are used to describe like parts. The rotary planing tool of the fourth embodiment is much smaller than the previous embodiments, having a disk 13 diameter of about 50 mm for use in finer work, and is intended to be fitted to an extension arm 46 which in turn is fitted to an angle grinder 17. The extension arm 46 is attached to the safety guard mounting points of the angle grinder, after the safety guard has been removed. The extension arm has a 1:1.5 ratio belt drive to step up the speed of the disk from a nominal 10,000 RPM or 12,000 RPM to 15,000 RPM or 18,000 RPM. The extension arm 46 has a large toothed pulley which attaches to the angle grinder driving a smaller toothed pulley via a toothed drive belt, to give the aforementioned ratio.

The fourth embodiment of the rotary planing tool 11 also differs in that the radial void 33 is not an aperture but rather is a scalloped recess 47 extending ahead of the blades 29. The scalloped recess 47 has an opening 49 above the outer circumference to promote discharge of shavings. The disk 13 of this embodiment is solid, not having its rear machined out, as this is not necessary on the smaller disks as weight is not an issue (the larger disks have issues with gyroscopic forces because of greater diameter and mass) and the smaller rotary cutting tools work best with the shavings being flung out the sides.

In this fourth embodiment, the outer circumference 31 is unbroken, as in the previously described embodiments, and the blades 29 do not extend beyond the outer circumference 31. In this manner, the outer circumferential edge 31 may run on the work piece, without biting, planing or abrading, and planing will not commence until the rotary planing tool 11 is tilted down to expose the raised annular surface 27 to the workpiece 37.

In this fourth embodiment each of the two radially extending blades 29 is a true circular disk 51. As can be seen in the drawings, the raised annular surface 27 has a radius of curvature greater than the radius of curvature of the true circular disk 51, so that the cutting edge 53 provided by the true circular disks 51 extends proud of the rotary raised annular surface 27 (but not beyond the outer circumferential edge 31). The true circular disks 51 are slightly frustro-conical in shape so as to make the cutting edge 53 protrude most effectively for cutting, and the leading face 55 of each true circular disk 51 is concave, also to promote effective planing.

The scalloped recesses 47 take their shape as a result of the use of a mill used to machine the material through the raised annular surface 27 in order to provide seats on which each true circular disk 51 is secured.

As in the previous embodiments, the disk 13 includes a recessed central portion 39 with a lower elevation in which the central circular aperture 15 is located. This provides for the mounting nut 21 and spindle 19 of the mini grinder 17 to be recessed, so they do not come into contact with an object being worked by the rotary planing tool. Located between the recessed central portion 39 and the raised annular surface 27, is an annular step 61. The surface of the annular step 61 is parallel to the plane of the disk 13 and is located exactly half way down the the true circular disk 51. This governs the true circular disk 51 from cutting too deep which should it do so, would prevent the rotary planing tool 11 from moving in the plane of the disk 13, due to the outer circumference becoming buried in the workpiece 31. In other words, if the rotary planing tool 11 was brought down onto a flat surface, it would only cut down to half way up the true circular disk 51 and would be able to move around in the plane of the disk 13 while removing material to the depth of half the diameter of the true circular disk 51. If the rotary planing tool 11 comes up against a guide or template however, it will be limited by outer circumferential surface 31.

It will be appreciated that depending on the required aggressiveness of the rotary planing tool 11, the height of the annular step 61 from the raised annular surface 27 may be reduced for a less aggressive planing action, and may be increased for a more aggressive planing action, though with the height increased it will be understood that tilting of the rotary planing tool 11 from parallel to the workpiece would be required, in order to overcome the effect of the circumferential edge being buried in the workpiece. The presence of the annular step 61 is important for control of the tool 11 in freehand planing, and the height of the annular step 61 from the raised annular surface is a matter of tuning, depending on the required characteristics of the rotary planing tool.

The disposition of the disks 51 forming the blades 29 is also such that their cutting edges 53 extend substantially radially in the sense that they extend at an angle of about 3 degrees from the true radius from the center of the disk 13, with the inner part of the blades 29 trailing the outer part, in the direction 30 of rotation of the disk 13. With a smaller disk diameter, the angle does not need to be as great as is the case with the first three embodiments.

The true circular disks 51 are each secured using an in-hex set screw 57 which is a button tooth and tapered (self locking) screw, recessed in the leading face 55, and received in a threaded hole 59 in the disk 13 within the raised annular portion.

With the true circular disks 51 being removable from the disk 13, the blade may be rotated if it becomes blunt across a particular arc, and may be replaced if it becomes blunt, and if serviceable, it may be resharpened.

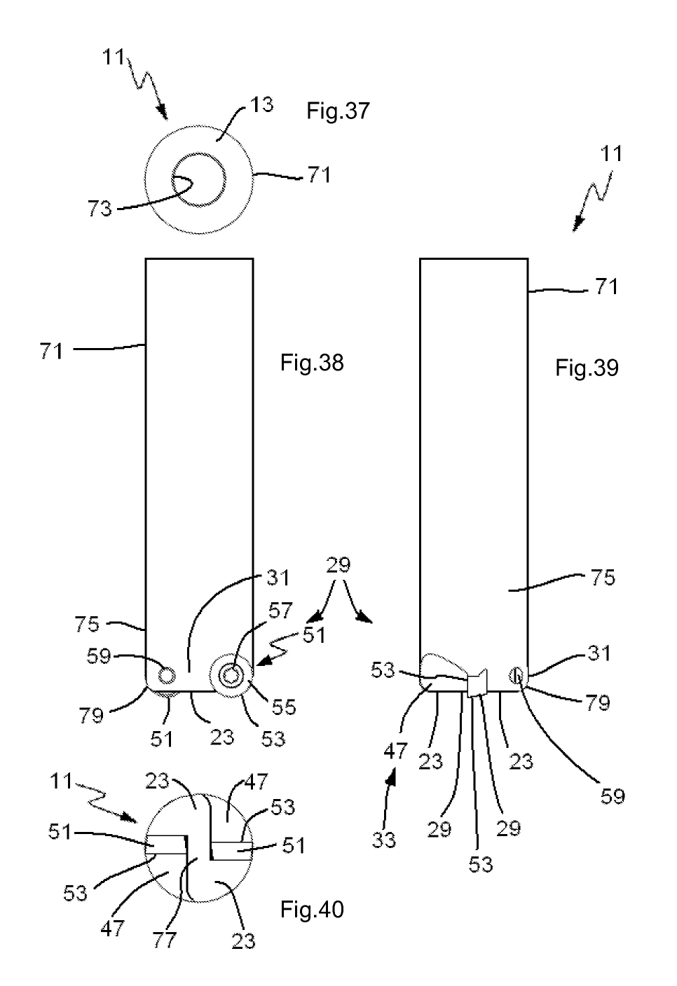

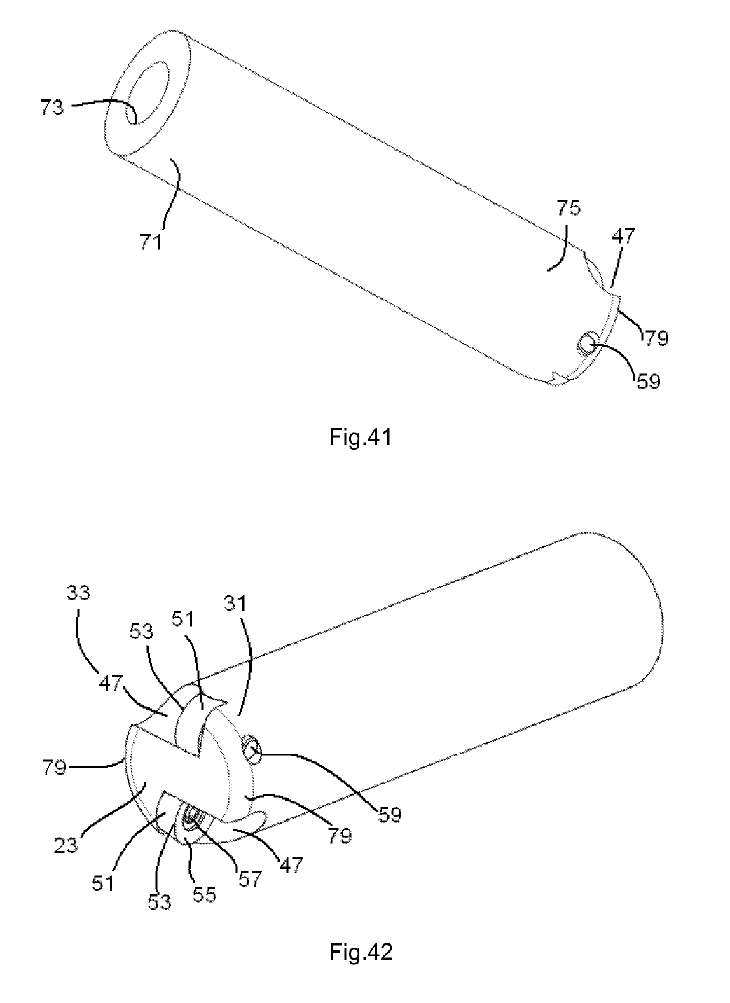

The rotary planing tool 11 of the fifth embodiment is similar to the fourth embodiment, and is illustrated in FIGS. 37 to 43. The rotary planing tool 11 of the fifth embodiment comprises a disk 13 of elongate construction (so as to form a rod-like structure) which is machined from steel and has a mounting end 71 to be mounted to an angle grinder 17. The mounting end 71 is provided with a threaded aperture 73 extending coaxially into the mounting end 71, to be screwed onto a male adaptor (not shown) which fits to the angle grinder 17 using the typical fitting that grinding or cut-off disks use.

At the opposite end 75 to the mounting end 71 is provided a working radial surface 23 which extends flat across the radius 77 of the opposite end 75 and has a smoothly curved circumferential edge 79 tending to the outer circumference 31 of the rotary planing tool 11.

In this fifth embodiment each of the two radially extending blades 29 is a true circular disk 51, which are the same as used in the fourth embodiment. The cutting edge 53 provided by the true circular disks 51 extends proud of the working radial surface 23, but not beyond the outer circumferential edge 31. The true circular disks 51 are slightly frustro-conical in shape so as to make the cutting edge 53 protrude most effectively for cutting, and the leading face 55 of each true circular disk 51 is concave, also to promote effective planing.

Voids 33 formed by scalloped recesses 47 take their shape as a result of the use of a mill used to machine the material through the working radial surface 123 in order to provide seats on which each true circular disk 51 is secured. The true circular disks 51 are each secured using an in-hex set screw 57 which is a button tooth and tapered (self locking) screw, recessed in must be tipped to expose the working radial surface 23 to fun the leading face 55, and received in a threaded hole 59 in the disk 13 within the working radial surface 23.

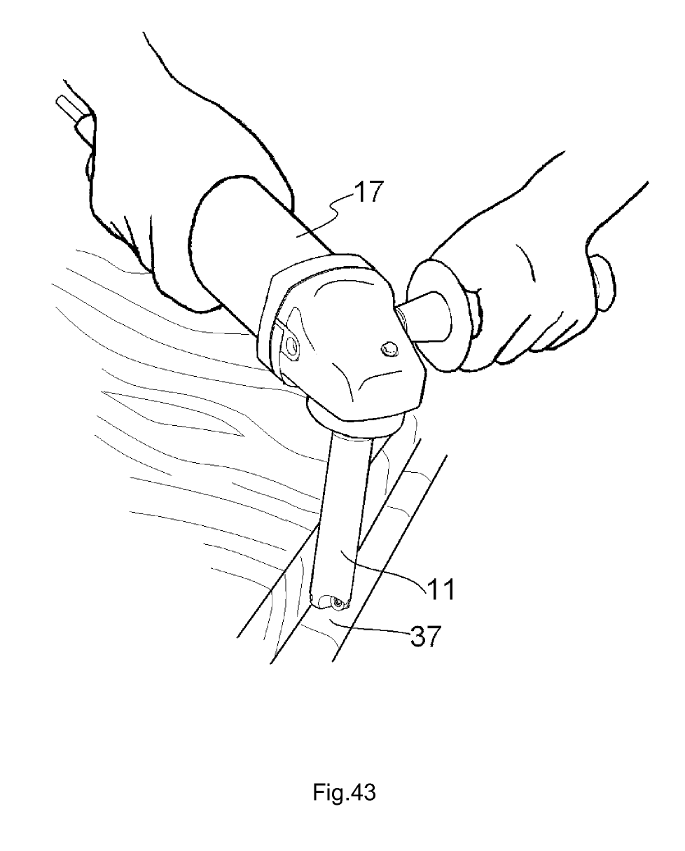

The working radial surface 23 provides a depth limiter for axial ingress of the rotary planing tool 11, meaning that the rotary planing tool 11 must be moved about in its circumferential plane in order to plane down into the workpiece 37. With the blades not extending past the circumferential edge 31, the rotary planing tool will not plane at its circumferential edge 31, but the surface running against the workpiece 37 must be tipped to contact the smoothly curved circumferential edge 79 and blades 29 to begin planing, and to a tilted position as shown in FIG. 43, to plane and sculpt the workpiece 37. The angular disposition of the blades 29 of this embodiment differs from the previous embodiments, while being angled from the true radius so that the planing action is good, differs in that the outer edge of the blade trails the inner edge. With the diameter of the rotary planing tool being smaller, this change does not lead to control difficulties as would be the case with a larger diameter.

The invention provides a radical departure from hitherto known freehand wood shaping blades which cut at their perimeter, giving rise to some unexpected advantages. In summary, the rotary planing tool 11 has a rotary planing action, cutting at 90° to the plane of the disc; however, the perimeter is benign and will not cut.

The rotary planing tool 11 is circular while the cutting surface is half a torus shape being divided at 90° to the central axis. The rotary planing tool 11 is mounted on a shaft located in the centre along the central axis and is driven by a rotary tool (angle grinder 17 or drill, but preferably an angle grinder) such that it rotates about the central axis. The carbide cutting blades are also semi circular and are raised above the half torus shape such that they are able to cut a surface (preferably wood). This cutting action is primarily across the radius of the central axis but in the direction away from the driving means.

If laid flat against a surface to be cut whilst rotating, the carbide blades will shave the surface in a manner similar to a wood plane but moving in a circular direction. The blades will enter the surface but the cutting depth will be limited by the surface of the bulk of the half torus shape. In other words, the parts in front of and behind the blades act in a similar manner as the heel and toe of a normal wood plane.

The blades are curved in profile such that the side edge portions of the cutting action are always out of the surface while cutting. If the blades had square corners they would tear a wood surface and leave lines or score marks. Because the curved profile in the blades is gradual and because the rotary planing tool 11 rotates rapidly, there is generally no visible marks. In other words the surface looks smooth and planed.

The carbide blades themselves being curved and extending into the recess 39, are able to cut into direction towards the centre of the torus 27 and away in the plane of the disk 13. At the outer circumference 31 however, the extent of the blades become progressively less until they meet the outer edge 31 of the half torus where upon a benign edge continues for a length of at least a few millimeters. The consequence of this is that if the rotary planing tool 11 is laid flat against a surface and rotating, it will cut and plane that surface indefinitely in the direction of the axis away from the driving means and in the plane at right angles to the axis, but only to a depth relating to the curve and exposure of the blades. So if the rotary planing tool 11 is laid flat to plane a surface (say wood) it can be moved along that surface but only to a depth ideally of a few millimeters. If the rotary planing tool 11 comes against a surface at right angles to the surface being planed, such as a guide or template, it will stop moving along that plane because there is no circumferential exposure of the blades at right angles to the plane of the disc. If the rotary planing tool 11 is moved backwards and forwards along the fence which is higher than the exposure of the tips, it will continue to cut indefinitely down in the direction of the axis away from the driving means. If the fence is removed after such action, it will continue to follow the profile left by the fence.

The rotary planing tool 11 is primarily designed to be used in a freehand manner to shape or plane wood. The benign outer perimeter means that fences, guides or templates can be used with the added ability to depart from the fence at will and in a controlled manner either following the profile of the template or guide, or moving from the controlled profile to free form. This can be achieved by angling the blade such that it moves away from the profile of the guide or template, or by twisting the blade in such a manner that it cuts a curved profile dictated by the angle of the blade but with the benign perimeter of the blade still contacting the guide or template; or a combination of both.

If the rotary planing tool 11 of the invention is brought into contact with a surface at right angles to the axis, i.e. if the outer circumference 31 contacts a surface at exactly right angles, it will ride on the surface but will not cut or grab. If however the operator tilts the blade so that the cutting tips start to contact the surface, it will start to cut but only in the direction of the axis away from the driving means.

This allows precise control of the aggressiveness of cutting at the perimeter. To cut a hollow such as a bowl shape into a piece of wood, one scoops the blade into the surface in a similar manner as an ice cream scoop. The advantage of this method is that the blade rides on the benign perimeter giving excellent control and preventing the perimeter from biting or grabbing in a confined space or corner. This avoids the problem of prior art woodshaping tools that cut at the edges, which can be particularly hazardous in a tight space or corner where teeth on the perimeter can bite into the wood causing the machine to lose control or kick back.

It should be appreciated that the scope of the invention is not limited to the particular embodiments described herein, and that changes may be made within the teachings of the embdiments without departing from the spirit and scope of the invention.

What is claimed is:

1. A rotary planing tool comprising a disk having a central mount for mounting on a motor, the rotary planing tool having a working radial surface in which substantially radially extending blades are attached, the working radial surface having a radial void extending before a leading edge of each radially extending blade, said radially extending blades extending proud of said working radial surface, said each said radially extending blade having a curvature tending away from the working radial surface into the circumference of said disk, and each said radially extending blade being arranged to not extend past the outer circumference of said disk.

2. A rotary planing tool as claimed in claim 1 wherein the radially extending blades extend proudly from the working radial surface in a smooth transition in height from being flush with the circumferential edge to a maximum height of the radially extending blades at a position or extent along said working radial surface way from the circumferential edge.

3. A rotary planing tool as claimed in claim 1 wherein the working radial surface has a raised annular portion, and a recessed central portion in which said mount is located.

4. A rotary planing tool as claimed in claim 3 wherein the radially extending blades extend entirely across said raised annular portion.

5. A rotary planing tool as claimed in claim 3 wherein the radially extending blades have a curvature tending away from the working radial surface into the recessed central portion, on an inner circumference of the raised annular surface.

6. A rotary planing tool as claimed in claim 5 wherein the radially extending blades extend proud of the inner circumference of said raised annular portion and in said recessed central portion.

7. A rotary planing tool as claimed in claim 6 wherein the radially extending blades have a gradually decreasing bite tending into said recessed central portion.

8. A rotary planing tool as claimed in claim 1 wherein the radially extending blades cutting edges trail the true radial extent of said disk.

9. A rotary planing tool as claimed in claim 1 wherein the the inner edge of the blade trails the outer edge across the raised annular portion.

10. A rotary planing tool as claimed in claim 1 wherein the radially extending blades cutting edges are pitched at an angle to the true radial extent of said disk.

11. A rotary planing tool as claimed in claim 10 wherein the angle lies in the range of from 3 degrees to 30 degrees.

12. A rotary planing tool as claimed in claim 10 wherein the angle lies in the range of from 5 degrees to 25 degrees.

13. A rotary planing tool as claimed in claim 10 wherein the angle lies in the range of from 10 to 20 degrees.

14. A rotary planing tool as claimed in claim 10 wherein the angle is about 15 degrees.

15. A rotary planing tool as claimed in claim 1 wherein the maximum height that the cutting edges extend from the working radial surface is up to 4 mm,

16. A rotary planing tool as claimed in claim 1 wherein the maximum height that the cutting edges extend from the working radial surface is from between 1.5 mm to 2.5 mm.

17. A rotary planing tool as claimed in claim 1 wherein the radial void extending before a leading edge of each radially extending blade comprises an aperture extending entirely through the working radial surface.

18. A rotary planing tool as claimed in claim 17 wherein each aperture extends before a leading edge before the radial extent only of each radially extending blade, so that the circumferential edge of the disk is unbroken.

19. A rotary planing tool as claimed in claim 1 wherein the radial void extending before a leading edge of each radially extending blade comprises a recess located in front of each radially extending blade.

20. A rotary planing tool as claimed in claim 1 wherein the radially extending blades each comprise a true circular disk, and the raised annular surface has a radius of curvature greater than the radius of curvature of the true circular disk.

21. A rotary planing tool as claimed in claim 20 wherein each radially extending blade is removable from the disk.

22. A rotary planing tool as claimed in claim 20 wherein each radially extending blade is removable from the disk, and is secured thereto by a screw, centrally located in the true circular disk.

23. A rotary planing tool as claimed in claim 22 wherein the true circular disk has a concave radial leading surface.
